(19) United States
(12) Patent Application Publication
(10) Pub. No.: US 2005/0222951 A1
(43) Pub. Date: Oct. 6, 2005

(54) Systems and methods of targeting savings

(76) Inventor: Lawrence M. Sherman, Westport, CT (US)

Correspondence Address: MINTZ, LEVIN, COHN, FERRIS;GLOVSKY and POPEO, P.C., One Financial Center, Boston, MA, 02111, US

(21) Appl. No.: 10/817,139

(22) Filed: Apr. 2, 2004

(51) Int. Cl. G06F 17/60

(52) U.S. Cl. 705/40

(57) ABSTRACT

Systems and methods of targeting savings deposits are provided that enable a depositor, such as a customer of a financial institution, to save money for various purposes or goals. A financial institution can make offers for targeting savings deposits to its customers using a financial statement that the financial institution prepares and provides to its customers to report information related to customers' financial accounts. Such offers can be solicited or unsolicited and can include one or more targeted savings plans customized to meet customers' savings goals. The financial statement can be further used to enable customers to enroll in one or more targeted savings plans and to make savings transactions according to such plans. A credit card account statement can be used for such purposes such that customers can make targeted savings deposits along with making payments to credit card accounts.

### FIELD OF THE INVENTION

The invention relates to techniques for saving money and more particularly to techniques for targeting incremental savings.

### BACKGROUND OF THE INVENTION

In today's society, people have various ways of putting aside or saving money. Some of these ways include depositing money in an interest-bearing account such as a savings, checking, money market or individual retirement account managed by a bank or other deposit-gathering financial institution. Other ways include purchasing or investing in stocks, bonds, commodities or other similar investment instruments. Typically, an individual saver or depositor determines, usually on an ad hoc basis, how much money to save at any given time.

In addition, financial services providers including banks and brokerage firms provide individual depositors or investors with statements reporting the performance of certain financial activities managed on behalf of the depositors/investors. For instance, a bank typically issues a monthly statement reporting the balance of a depositing customer's various accounts such as savings, checking, individual retirement, money market and/or mutual fund accounts, as well as reporting the interest or income-earned on deposits and investments. Also, depositors/investors receive statements reporting the amounts owed to various companies, including credit card companies and brokerage firms, that typically describe the amounts depositors/investors owe and for what reason.

Despite the various ways of saving and investing and reporting monies saved and owed, a system or method of automatically targeting at least a portion of an individual's periodic deposits and investments for specific purposes that the individual would like to save for, and within certain parameters the individual and/or a financial institution designates, is lacking.

### SUMMARY OF THE INVENTION

The invention provides improved systems and methods for saving money that make it easy and fun to save money. The invention allows an individual to designate or target at least a portion of his/her money or periodic deposits toward saving for a particular purpose or goal and within certain parameters or variables the individual and/or a deposit-gathering financial institution designates. Thereafter, the individual can save money automatically and with ease to reach his/her purpose or goal of saving money. Such savings efforts can be integrated with the individual's existing financial accounts, allowing the set up of and participation in targeted saving to proceed with a minimal number of transactions and effort. In addition, targeted saving according to the invention can be configured to motivate and reward individual savings efforts.

In general, in one aspect, the invention provides a method of targeting savings comprising providing a request format to a user to target savings deposits, the request format being a part of a debit statement a financial institution provides to the user, composing a request to target savings deposits using the request format, the request including data the user designates, and sending the request format to the financial institution.

In another aspect, the invention provides a network-implemented system of targeting savings comprising at least one customer computing device operatively coupled to a network for operation by at least one user, and at least one central bank computing device operatively coupled to the network for operation by at least one financial institution, each of the central bank computing device and the customer computing device being configured and arranged to establish a communications and data exchange link with one another through the network. The central bank computing device is programmed to transmit to the customer computing device a request format for the user to target savings deposits, and the request format is a part of a debit statement the financial institution provides to the user. The central bank computing device is programmed to receive the request format the customer computing device transmits to the central bank computing device, the request format being composed by the user using the customer computing device and including data the user designates. In addition, the central bank computing device is further programmed to receive the request format with a debit payment to the financial institution the customer computing device transmits to the central bank computing device.

In a further aspect, the invention provides a method of targeting savings comprising providing a request format to a user configured to target savings deposits, the request format being a part of a statement a financial institution provides to the user, composing a request to target savings deposits using the request format, the request including data the user designates, and sending the request format to the financial institution.

Implementations of the method according to the invention may include one or more of the following features. The statement can include a credit card account statement, a mortgage account statement, a brokerage account statement, a checking account statement and/or a savings account statement. In addition, the statement can include targeted savings data related to one or more targeted savings efforts. The request format can be further configured as a payment coupon to identify payment of one or more periodic targeted savings deposits toward the one or more targeted savings efforts. In addition, the payment coupon is further configured to identify payment to an account for which the statement issues.

Implementations of the method according to the invention can further include the following features. The targeted savings data can include at least one of a target dollar amount of money to be saved, a purpose for saving a target dollar amount of money, a target date by which a target dollar amount of money is to be saved, an amount of a periodic targeted savings deposit, a balance of periodic targeted savings deposits paid and a rate of return on a balance of periodic targeted savings deposits paid. The statement can further include one or more design icons configured to represent the balance of periodic targeted savings deposits relative to a target dollar amount of money to be saved. The one or more design icons can include a design icon configured to represent an item to be purchased when the balance of periodic targeted savings deposits paid equals the total dollar amount of money to be saved. In addition, the targeted savings data can include one or more periodic targeted savings deposits paid toward one or more targeted savings efforts, and wherein the one or more periodic targeted savings deposits paid are represented in the statement as one or more account transactions. The user can designate one or more of a target dollar amount of money to be saved, a target date by which a target dollar amount of money is to be saved, a dollar amount for one or more periodic targeted savings deposits, and a purpose for which money is to be saved

The financial institution can provide the user at least one targeted savings plan configured in response to the user's request to target savings deposits. The at least one targeted savings plan can identify one or more of a target dollar amount of money to be saved, a target date by which a target dollar amount of money is to be saved, a dollar amount for one or more periodic targeted savings deposits, a purpose for which money is to be saved, and a rate of return on a balance of periodic targeted savings deposits. In addition, the financial institution can receive the one or more periodic targeted savings deposits the user pays. The financial institution can increase a balance of the one or more periodic targeted savings deposits by paying a rate of return on the balance. The financial institution can report at least a balance of the one or more periodic targeted savings deposits. The financial institution can further redeem a balance of the one or more periodic targeted savings deposits to the user when the balance equals a target dollar amount of money to be saved.

Various aspects of the invention may provide one or more of the following advantages. Users can have predetermined amounts of money deposited periodically in one or more financial accounts designated for a particular reason and/or savings objective. A designated financial account can be a new account set up for purposes of targeting incremental savings or can be an existing account with which targeted saving is integrated. Once a new account is set up or an existing account is designated, a user can save incrementally with little or no effort, and without extra steps or measures for saving. Reasons or objectives for saving can include saving for personal use, such as saving a total or target amount of money and/or saving money by a certain target date in order to, for instance, purchase one or more specific items and/or achieve one or more return or investment goals. Amounts of money can be deposited into the designated target account either through active user depositing or can be taken automatically from other user accounts. For instance, a user can target savings in conjunction with any type of account such as a credit card account whereby the user can make periodic targeted savings payments/deposits to his/her credit card account along with making the required payments toward the credit card account balance.

An account designated for targeted saving can enable a user to essentially pay him/herself, before or in addition to paying other obligations, and to designate such payments/deposits for one or more specific purposes. In addition, a targeted saving account can enable a user to earn extra money through interest or income-earned, or otherwise to exceed predetermined amounts of money taken from or deposited by a user for targeted savings. Balances of targeted savings deposits can be augmented in accordance with, for instance, a type of savings or investment scheme/account that a user selects and/or a class of securities that the user designates for investment. Monies for different savings reasons or objectives from a single user can be combined to increase the earning potential of the user's monies being saved. Monies from different users designated or targeted for one or more savings reasons or objectives by one or more of the users can be combined to increase the earning potential of the monies being saved.

A user can incrementally save a target or dollar amount of money and/or can save money by a target or success date in accordance with a targeted saving schedule or plan a financial institution that manages the designated accounts offers to the user. Targeted incremental saving, as described herein, can enable a user to acquire one or more specific items and/or to achieve one or more return objectives at an actual cost of such items or objectives, and by minimizing or without incurring credit debt.

Feedback can be provided to a user to report the status of targeted saving and to reinforce his/her savings efforts. Feedback can be provided through textual, visual, audio, and/or any other creative means to further reinforce savings and to motivate a user to reach the particular reason or objective of saving. In particular, feedback can be provided to a user by incorporated targeted savings data in a financial account statement, such as a debit statement, including a credit card account statement, a mortgage account statement and a brokerage account statement, or a checking or savings account statement.

Deposit-gathering financial institutions would benefit by offering the additional services of targeting saving deposits to existing and potentially new clients and attracting more clients (such institutions would have a competitive advantage over other institutions that did not offer target saving services) and more deposits from existing clients. Credit card companies in particular would benefit from being able to attract deposits to partially fund their credit card balances. Such companies could charge or imbed management fees in a rate of return that they pay for the liability balances.

These and other advantages of the invention, and the invention itself, will be more fully understood from the following drawings, description and claims.

### BRIEF DESCRIPTION OF THE DRAWINGS

FIG. 1 illustrates a network-implemented system of target saving according to the invention;

FIG. 2 is a block diagram illustrating a customer computing device used in the system shown in FIG. 1;

FIG. 3 is a block diagram illustrating a central bank computing device used in the system shown in FIG. 1;

FIG. 4 is a flow diagram of a method of targeting savings implemented via the system shown in FIG. 1;

FIG. 4A is a flow diagram of a method of targeting savings according to the invention;

FIG. 5 is a flow diagram of a further method of targeting savings according to the invention via one or more traditional methods of interaction and communication;

FIG. 6 shows an exemplary request for targeted saving according to the invention;

FIG. 7 shows an exemplary form for setting up and/or designating one or more accounts for targeted saving according to the invention; and

FIG. 8 shows an exemplary statement for reporting the status and the progress of a user's targeted saving according to the invention.

### DETAILED DESCRIPTION OF PREFERRED EMBODIMENTS

At least some embodiments of the invention provide systems and methods for targeting incremental savings. Embodiments of target saving systems and methods according to the invention enable a customer to specify or target a designated dollar amount of the customer's periodic savings deposits for one or more specific purposes and/or to designate one or more specific dates by which the customer would like to have saved the designated dollar amount(s). For instance, a customer can target at least a portion of his/her savings deposits for purchasing one or more items or for attaining one or more investment goals. The invention enables a customer and/or a deposit-gathering financial institution to target at least a portion of the customer's deposits in terms of a specific item or purpose, a target or total dollar amount of money to be saved, and/or a target or success date by which the total dollar amount is to be saved. The invention enables a financial institution to use such terms and/or other variables to formulate a customized targeted savings plan that is tailored to meet the customer's needs and savings objectives. The customized targeted savings plan according to the invention can include a payment schedule by which the customer makes a predetermined number of payments. Each payment can be a certain dollar amount in order to save a target dollar amount of money by a required or desired target date. The targeted savings plan can be offered and executed between a customer and a financial institution through a financial statement whereby the financial institution provides in the financial statement one or more solicited or unsolicited offers for targeted savings and the customer responds by requesting targeted savings. Terms or variables other than those described herein can be used to establish a customized targeted savings plan according to the invention including, for instance, a class of investment securities that a customer designates to be purchased with targeted saving deposits.

The invention can be executed in different ways, as described herein. Embodiments of the invention can be integrated with one or more new or existing financial accounts that a customer maintains, such as a credit card account, a savings account, a checking account, a mortgage account, a mutual fund account, a brokerage account and any other account that increases an amount of money beyond that which a customer deposits. The invention permits a customer to set up one or more new accounts and/or to designate one or more existing accounts for targeted saving. For instance, a customer and/or a financial institution can designate an existing account, e.g., a credit card account, for targeted saving whereby at least a portion of the customer's periodic payments or deposits, or a portion of the interest or income earned on the account's balance, is designated for a specific purpose. In another instance, one or more accounts used for targeted saving, either exclusively for targeted saving or in addition to other savings or investment purposes, can be linked to any of a variety of other financial accounts of the customer. Once the target saving account is set up or is designated, targeted saving according to the invention can proceed thereafter manually through active customer depositing and/or automatically with little or no customer effort or involvement, providing an easy and customized method of reaching savings objectives.

Systems and methods according to the invention can aggregate targeted saving deposits or payments with other accounts or funds belonging to a customer and/or a financial institution to increase a savings or investment pool and to thereby maximize the interest earned or investment return on such deposits. In accordance with the invention, a financial institution can invest the customer's targeted savings in aggregate traunches for purchasing different securities, depending on the investment scheme or the type or class of securities the customer designates, in order to maximize the customer's return. A rate of interest or income earned by targeted saving deposits can vary depending on the type or class of investment security a customer designates or selects such as, for instance, fixed income or equity investment securities. A rate of return can also vary in accordance with an expected duration of an investment/account balance to maturity. The expected duration to maturity can include the duration between time of a specific deposit and a target date by which a target dollar amount of money is to be saved.

Embodiments of the invention further provide for reporting the progress and the status of a customized targeted savings plan that provides a customer with an indication of his/her success. Reporting the progress and the status of a targeted savings plan can include current and historical data concerning a specific target saving account and/or other financial accounts, and can further provide incentives to a customer for meeting the requirements of a targeted savings plan and/or for reaching the return objectives. Progress and status reporting can be executed in different ways, as described herein, including visual, audio and/or textual systems and methods.

Embodiments of the invention can be configured and arranged in different ways such that various approaches to implementing, operating, supervising, managing and/or reporting incremental targeted saving are possible and envisioned. The invention includes at least one identified customer and at least one participating, deposit-gathering financial institution. Some embodiments of the invention provide a computer or network-implemented system to operate, supervise, manage and/or report electronically targeted saving wherein communications and transactions between one or more identified customers and one or more deposit-gathering financial institutions occur substantially or entirely through a computer or other electronic network. Some embodiments of the invention can include electronic systems such as, for instance, electronic text mail (email) and audio (voice mail) systems. Other embodiments of the invention can include one or more traditional systems or modes of customer interaction and correspondence, including telephone, facsimile and/or postal mail communication. Still further embodiments of the invention can include combinations of computer or network-implemented, electronic and traditional systems and methods of communication and correspondence to practice target saving according to the invention. Other embodiments, in addition to those described herein, are within the scope and spirit of the invention.

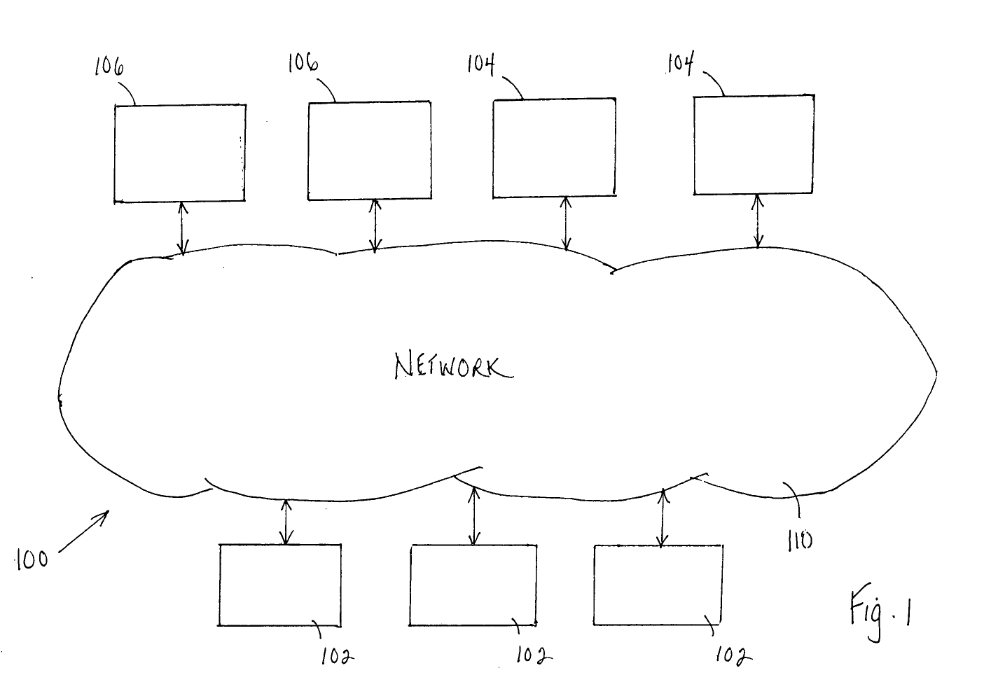

Referring to FIG. 1, in one embodiment, the invention provides a system 100 incorporated with or implemented on one or more networks 110. The system 100 includes a plurality of customer general purpose computing devices 102 operatively connected to at least one network 110. Each customer computing device 102 can be owned and operated by a different customer including, but not limited to, an individual, a business, a corporation, an association or organization, a public entity or organization, a private, non-profit or charitable entity or organization, and/or an intermediary or agent for any of the foregoing. The system 100 further includes one or more central bank computing devices 104 and, optionally, one or more information servers 106 operatively connected to the network 110. Each central bank computing devices 104 or server 106 can be owned and operated by a different financial institution including, but not limited to, a bank, a credit card company, a brokerage firm, a mutual funds company, any other financial services provider, and/or an intermediary or agent for any of the foregoing.

The network 110 interconnects the computing devices 102, 104 and 106 and allows the devices to communicate with one another and/or with any other computing devices and/or servers. The network 110 can include a Local Area Network (LAN) and/or a network that uses the transmission control protocol/Internet protocol (TCP/IP) suite of protocols, such as the Internet, such that the computing devices 102, 104 and 106 can communicate with one another and/or with any other computing devices and/or servers via the Internet 110. In addition, the network 110 can include dedicated data transmission lines or a cellular, microwave or satellite network to provide operative connections between the computing devices 102, 104 and 106.

Referring further to FIG. 1, the system 100 can be configured as a server-customer system wherein the one or more servers 106 operatively connected to the network 110 are accessible via the customer computing devices 102. A server 106 can be accessed from a customer computing device 102 via software operating in the device 102 including a web browser application, such as INTERNET EXPLORER® available from Microsoft of Redmond, Wash., that allows the customer computing device 102 to send requests to the server 106. The server 106 is configured to receive requests from the customer computing device 102 and to retrieve and provide information in response to such requests. In one embodiment, the server 106 can provide access to and/or display information via the customer computing device 102. The server 106 can provide the information, for instance, as hypertext markup language (HTML) documents and/or through accessible related software. In those embodiments in which the system 100 includes the Internet as the interconnecting network 110, the server 106 can present information using different types of world wide web (WWW) documents including, for instance, one or more web pages written in HTML and/or a web site comprising one or more HTML documents and associated files and databases.

In addition, in one embodiment of the invention, the central bank computing device 104 can be configured to act as a server 106 to present information to a customer computing device 102 as HMTL documents and accessible software, and/or as world wide web documents or web pages, in response to requests received from the customer computing device 102 and/or in response to receipt of information the customer computing device 102 transmits to the central bank computing device 104.

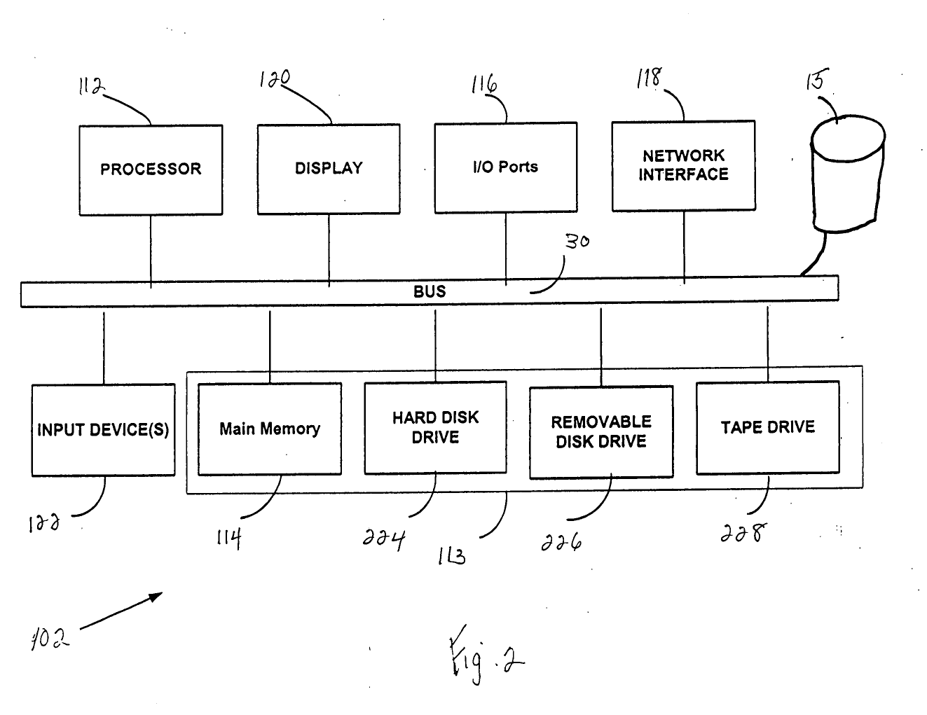

Referring to FIG. 2, the customer general purpose computing device 102 can include, but is not limited to, a mainframe computer, a personal computer (PC), a laptop computer, an electronic notebook, a personal digital assistant (PDA), a mobile communications device, an Internet appliance, a workstation, an interconnected group of computers and/or any other device being capable of running any one of a variety of operating systems and/or software programs configured to help to implement, enact and support target saving according to the invention and having a direct or indirect ability to connect, or is connectable in any known or later-developed manner, to the network 110.

A block diagram of a customer general purpose computing device 102 usable in at least one embodiment of the invention is shown in FIG. 2. The computing device 102 can include a central processing unit (CPU) 112, associated memory 113 for storing software and data, one or more input/output ports 116, a network interface 118, a display device 120, one or more input devices 122 and a data bus 130 operatively connecting these components to allow communication between the components.

The central processing unit 112 can include one or more of any type of microprocessor, such as a PENTIUM® microprocessor manufactured by Intel of Santa Rosa, Calif. The associated memory 113 can include main memory 114, a fixed or hard disk drive unit 224, a removable disk drive unit 226, e.g., a CD-ROM or floppy disk drive, and/or a tape drive 228. The associated memory 113 can also include random access memory (RAM), read only memory (ROM) and/or compact disk read-only memory (CD-ROM) to store software programs and data. The display device 120 can include any type of display capable of displaying outputs, in whole or in part, generated in accordance with systems and methods of target saving according to the invention including, but not limited to, a liquid crystal display (LCD), a cathode ray tube display (CRT) and a light emitting diode (LED). The input device 122 can include any type of device capable of providing the inputs described herein including, but not limited to, a keyboard, a numeric keypad, a touch screen, a pointing device, a switch, a stylus or a light pen. The network interface 118 can include any type of device, card, adapter or connector that provides the customer computing device 102 with wired or wireless access to the network 110 and other computing devices.

Those skilled in the art will appreciate that the customer computing device 102 need not include every element shown in FIG. 2, and that equivalents of each of the elements shown are intended to be included within the scope and spirit of the invention.

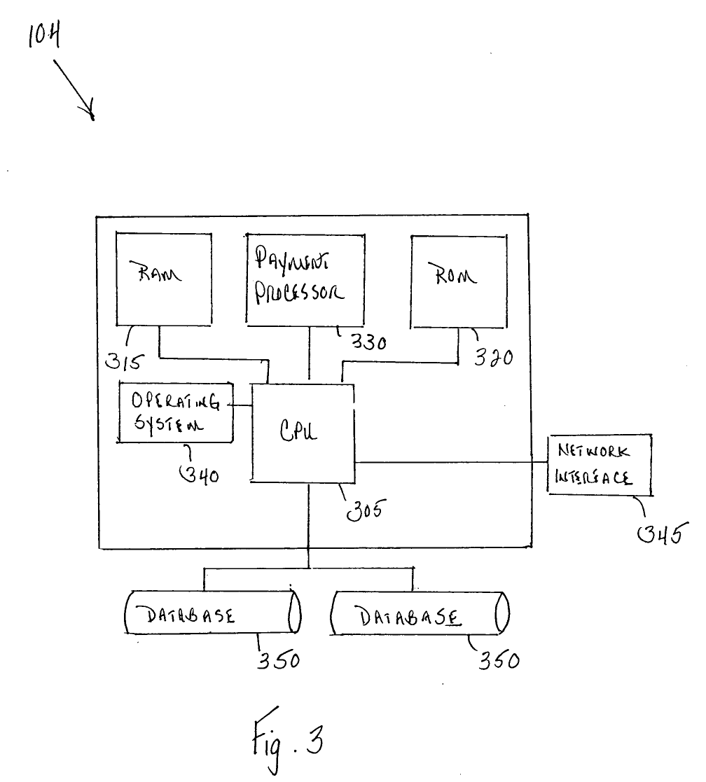

Referring to FIG. 3, and with further reference to FIG. 1, the central bank computing device 104 is configured to implement, perform, supervise, manage and/or store information related to financial transactions for one or more customer computing devices 102 including, for instance, maintaining account and/or transaction information for each of the customer computing devices 102. A block diagram of the central bank computing device 104, usable in at least one embodiment of the invention, is shown in FIG. 3. The central bank computing device 104 can include a central processing unit (CPU) 305, memory including random access memory (RAM) 315 and read-only memory (ROM) 320, a payment processor 330, an operating system 340, a network interface 345 and a data storage device 350. The payment processor 330 may be configured as part of the CPU 305 or can include one or more microprocessors, such as a PENTIUM® microprocessor manufactured by Intel of Santa Rosa, Calif. The payment processor 330 can be supported by commercially available software to support transfers and exchanges of payments, charges and/or debits as required for target saving according to the invention. The network interface 345 provides a wired or wireless connection to the network 110 to permit communication with the customer computing devices 102. The data storage device 350 can include one or more storage units such as, but not limited to, hard disk magnetic or optical storage units. The date storage device 350 can further include one or more databases used in processing transactions according to the invention and used in managing and storing information related to customer accounts.

Those skilled in the art will appreciate that the central bank computing device 102 need not include every element shown in FIG. 3, and that equivalents of each of the elements shown are intended to be included within the scope and spirit of the invention.

In addition, the central bank computing device 104 can be arranged and configured to operate a software program or code that controls the computing device 104 to receive instructions from the customer computing device 102, e.g., indicating an item or goal for which the customer would like to target his/her savings, the target dollar amount of saving and/or the target or success date by which the target dollar amount is to be saved. The software program can also be coded to withdraw automatically deposits for targeted saving for the item or goal the customer wishes to purchase or attain. The software can instruct the computing device 104 to calculate required periodic payments in view of an expected interest rate or income to be earned on invested deposits, and in view of the target date and the total dollar amount to be saved. The software can further cause the computing device 104 to provide various data related to the customer's savings purposes for reporting to the customer. In addition, the software program or code can instruct the computing device 104 to print or to transmit the various data as a customer statement or other correspondence between the customer and the financial institution to effectively report to the customer the progress of his/her targeted savings efforts.

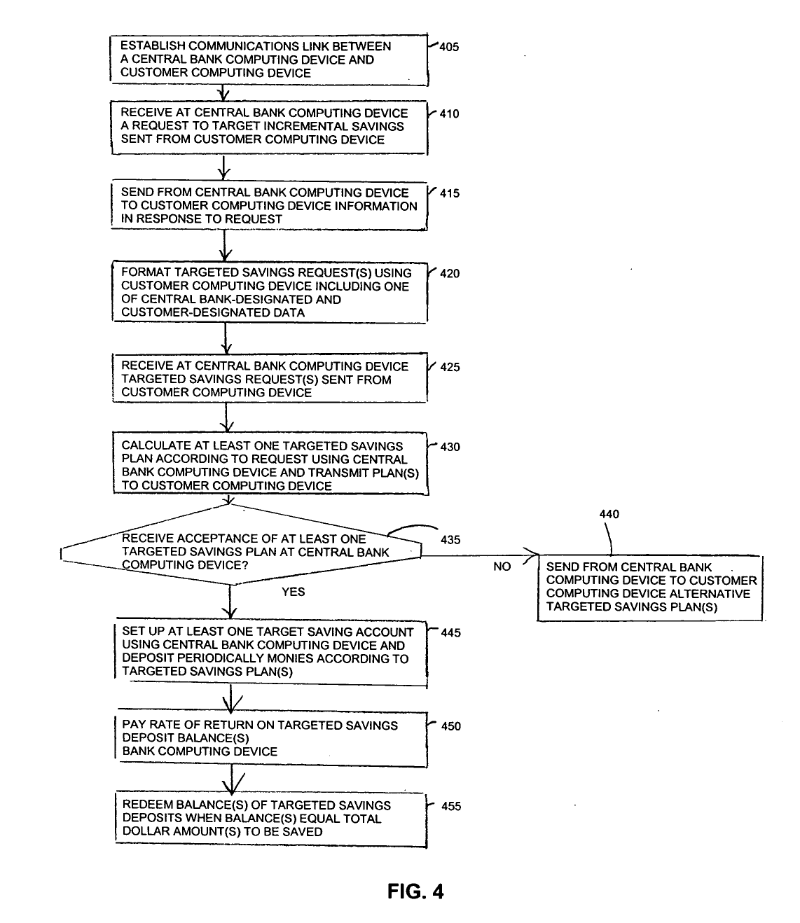

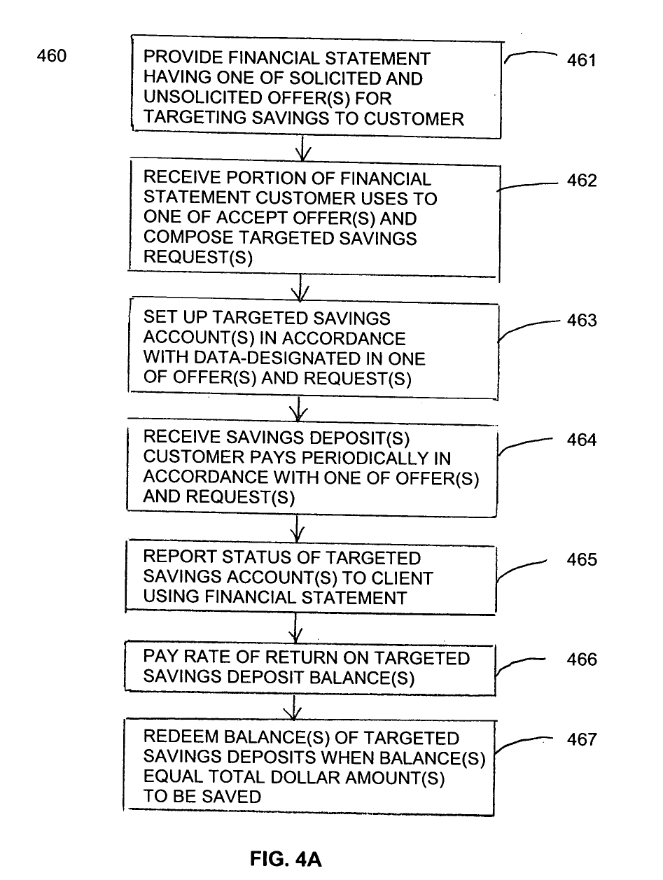

Referring to FIG. 4, the invention provides a method 400 of targeted saving that can be operated via the system 100 illustrated in and described with reference to FIGS. 1-3. The method 400 enables an identified customer at least to create one or more customized targeted savings requests, to communicate such requests to a financial institutional and/or to participate in one or more programs provided and/or serviced by the financial institution. As noted above, in one embodiment of the invention, the central bank computing device 104 can act as one or more servers 106. For purposes of disclosure of the method 400, the central bank computing device 104 is configured and arranged to act as one or more servers 106 operatively connected to the network 110 and the network 110 includes the Internet. The method 400, however, is exemplary only and not limiting. The method 400 can be altered, e.g., by having stages added, removed, or rearranged. Those of ordinary skill in the art will appreciate that the method 400 can be modified and varied in whole or in part by using other types of systems other than the system 100 described above, as well as by establishing one or more software programs or codes, to implement and control target saving according to the invention.

At stage 405, the central bank computing device 104 of a participating, deposit-gathering financial institution receives a signal from the customer computing device 102 operated by an identified customer to electronically connect the central bank computing device 104 with the customer computing device 102 via the Internet 110. A communications link between the central bank and the customer computing devices 102 and 104 is thereby established such that correspondence and data can be transmitted between the computing devices 102 and 104.

At stage 410, the central bank computing device 104 receives from the identified customer via the customer computing device 102 an inquiry indicating interest in targeted saving and/or a request for targeted saving. A request can include a request to set up a new target saving account, to add to or modify an existing target saving account, and/or to enact a targeted savings transaction, e.g., make a deposit or an investment payment.

At stage 415, in response to receipt of the inquiry and/or the targeted savings request, the central bank computing device 104 transmits information to the customer computing device 102 and makes the information available to the customer, e.g., by displaying the information on the display device 120 of the customer computing device 102. The central bank computing device 104 can present the information, for instance, as one or more world wide web (WWW) pages written in HTML and, optionally, can make available any associated documents and software. Through an interface of a web browser application, such as INTERNET EXPLORER® available from Microsoft of Redmond, Wash., the customer can access the web pages and associated documents and, if required or desired, can download associated software.

In some embodiments, the information that the central bank computing device 104 presents includes information about one or more targeted savings programs the financial institution offers. In other embodiments, the information that the central bank computing device 104 presents includes any of a variety of formats, such as a form or questionnaire. The customer can use such formats to create or compose either an inquiry for further information about targeted saving, a request to set up a new target saving account, or to add to and/or modify an existing target saving or other account. In one embodiment, as described below in further detail, such formats can be included with a financial statement the financial institution provides to the customer such as a debit statement. In addition, the central bank computing device 104 can present a format by which the customer can initiate one or more financial transactions, e.g., deposits, payments or withdrawals, associated with one or more new or existing target saving or other accounts. In one embodiment, the central bank computing device 104 can make available or present a form or questionnaire to a customer via the customer computing device 102, for instance, as one or more web pages or HMTL documents that the customer can interact with and complete, e.g., by inputting data into the form or questionnaire via the computing device 102.

At stage 420, using the customer computing device 102, the customer provides or enters data using the input device 122, e.g., a keyboard, a mouse, a numeric pad or a touch screen, to compose and complete one or more targeted saving inquiries or requests, as described above. Depending on the nature of the request or transaction, the one or more formats the central bank computing device 102 presents to the customer can be configured to prompt the customer to enter or to select one or more inputs or variables to compose a request. Such formats can include portions or pages of a debit statement, e.g., a credit card statement that the financial institution provides to the customer.

The financial institution can use customer-designated variables to calculate or formulate a customized targeted savings plan and/or to set up a new target saving account, to modify an existing target saving account or to perform a targeted savings transaction. Targeted saving according to the invention can employ a range of different inputs or variables including, but are not limited to, (i) an item to be purchased or an investment goal to be met with the customer's targeted deposits; (ii) a purpose for obtaining the item or for attaining the goal; (iii) a target or total dollar amount of money to be saved; (iv) a target or success date by which the total dollar amount is to be saved; (v) a required or desired dollar amount of each incremental deposit or payment to be made toward the target dollar amount; (vi) a required or desired frequency of incremental deposits or payments; (vi) identification of at least a first or target saving account, e.g., as either a new or an existing account, into which incremental deposits or payments are to be paid for purposes of targeted saving; (vii) selection of a type of account, e.g., according to an interest or investment scheme the customer prefers or requires including, for instance, an interest bearing savings or checking account or a money market, mutual funds, fixed income securities and/or equity investment account; (viii) identification of at least a second or payment account from which monies will be manually or automatically withdrawn or debited to fund incremental deposits or payments to the first account; and/or (ix) identification of a method of payment, e.g., by electronic funds transfer, credit card, check or money order, to fund the first or target saving account. The invention is not limited to the inputs and the variables described herein to calculate or formulate a customized targeted savings request or transaction, and anticipates that other inputs and variables can be used to configure target saving accounts and investments to meet the customer's return objectives.

In addition, the financial institution can use variables it identifies to calculate or formulate a customized targeted savings plan, such as those variables described above. Such targeted savings plan(s) can be unsolicited or solicited by the customer. In those cases of unsolicited targeted savings plan(s), the financial institution can make such offer(s) using a financial statement, such as a debit statement, including a credit card statement. The credit card statement, thereafter, can be used to set up and to participate in a targeted savings program(s).

In some embodiments, the first or target saving account and the second or payment account can be the same account. For instance, a customer can deposit funds into a money market account for purposes of checking and investment, designating or targeting a portion of each periodic deposit for targeted saving according to the invention. In other embodiments, the first and the second accounts can be linked accounts at a single financial institution such as, for instance, linked checking and savings accounts between which monies can be transferred and withdrawn for purposes of targeted saving.

In further embodiments, the first and the second accounts can be different accounts. The first account can be one type of account, such as a credit card account, and the second account can be another type of account, such as a checking account, whereby a customer can make a payment to the credit card account with funds drawn from the checking account, e.g., by check or automatic funds transfer. A portion of the payment can include the periodic payment the financial institution requires on the credit card account balance and another portion can be a targeted savings payment/deposit directed toward saving a target dollar amount. In this case, when the customer sets up targeted savings through his/her credit card account, the financial institution can automatically increase periodic payments required on the credit card account to account for the targeted savings plan the customer has enrolled in. Similarly, the first account can be a savings account or a mortgage account and the second account from which funds are extracted, e.g., by check or automatic funds transfer, can be a checking account or a mortgage account. The invention envisions other types of accounts and arrangements for transfer and/or payment of targeted savings deposits.

At stage 425, the central bank computing device 104 receives the targeted savings request that the customer composes and transmits using the customer computing device 102 to submit the request to the financial institution. In one embodiment, if the request is sufficiently complete to process, the central bank computing device 104 can transmit to the customer computing device 102 an acknowledgement/message indicating successful completion and receipt of the request and/or indicating acceptance of the request.

At stage 430, in response to receipt of the targeted savings request, the central bank computing device 104 calculates one or more proposed targeted saving schedules or plans using one or more of the inputs or variables designated in the customer request, and transmits the proposed targeted savings plans to the customer computing device 102 for the customer to consider and either approve or reject. As will be described below in further detail, a targeted savings plan can indicate, for instance, a dollar amount of each incremental deposit or payment to be made to a target saving account and a required frequency of such deposits or payments to save a target dollar amount, e.g., by the target or success date.

In addition, in some embodiments, the targeted savings plan can further highlight the type of interest-bearing or investment account that the customer has selected or that the financial institution proposes, as well as the anticipated or projected earned interest or income. Such information can be provided regardless of whether the financial institution maintains the customer's targeted savings in one or more separate customer accounts or pools the customer's targeted savings with other customer accounts or investment pools that the financial institution manages. The targeted savings plan can also indicate a proposed fixed or variable rate of return on the targeted savings balance depending on the type of account or the class of investment securities the customer has designated in his/her request.

As noted above, in some embodiments, the central bank computing device 104 can present one or more request formats to a customer for the customer to compose a targeted savings request that permits the customer to designate or select specific inputs or variables related to targeted saving. For instance, a customer may not be required or permitted to designate a dollar amount of each increment deposit or payment or a frequency of such deposits or payments, but would be required or permitted to specify in the request a target dollar amount of saving, a target date, a type of account or class of investment securities, and/or a duration of investment to maturity. From these variables, the central bank computing device 104 thereby calculates and proposes the proposed targeted savings plan, identifying at least the dollar amount of periodic deposits and payments and the frequency of such deposits or payments.

Alternatively, in other embodiments, a customer may be required or permitted to designate in the targeted savings request a desired dollar amount of each periodic deposit or payment, a desired frequency of deposits or payments, a type of account or class of investment securities, and/or duration of investment to maturity. Upon receipt of the request, the central bank computing device 104 can calculate one or more targeted savings plans accordingly that at least include one or more proposed target or success dates and a target dollar amount of saving that can be achieved by each proposed date.

At stage 435, the central bank computing device 104 receives either an acceptance or a rejection of some or all of the proposed targeted savings plan(s) that the customer transmits using the customer computing device 102.

At stage 440, in the event the central bank computing device 104 receives a rejection of at least one of the proposed targeted savings plans, upon receipt of the rejection, the central bank computing device 104 can calculate and transmit to the customer computing device 102 one or more alternative targeted savings plans for consideration by the customer.

At stage 445, in the event the customer accepts at least one of the proposed targeted savings plans, upon receipt of the acceptance, the central bank computing device 104 can set up a new target saving account or can modify an existing target saving account according to the targeted saving variables designated by the customer in his/her request and/or in the accepted targeted savings plan. The computing device 104 can further transfer data provided in the targeted savings plan, e.g., along with customer information and instructions associated with the plan, to one or more databases for account information management and storage, supervision of targeted savings transactions, deposits and payments, and future reporting to the customer.

The customer thereafter makes one or more periodic targeted savings payments/deposits to the account designated for targeted savings according to one or more of the plans in which the customer has accepted and enrolled in. In one embodiment, the stage in which the financial institution offers the customer one or more plans and the customer makes one or more periodic targeted savings payments/deposits according to the one or more of the plans can be transacted through a debit statement, e.g., a credit card account statement, that the financial institution provides to the user. The debit statement can be used to format a targeted savings request and/or can be used by the financial institution to offer solicited and unsolicited targeted savings plans to the customer. The debit statement can be further used for targeted savings transactions whereby, for instance, the customer can make one or more targeted savings payments/deposits to a designated target saving account along with making payments to the debit account. In this case, the customer can make a debit account payment and a targeted savings payment/deposit at the same time and essentially can make his/her debit payment while depositing additional money for savings.

At stage 450, depending on the type of account and/or the class of investment securities the customer has designated in his/her targeted savings request, the financial institution that owns and/or operates the central bank computing device 104 pays an interest rate or earned income on an ascending balance of the targeted savings deposits, or a balance of an account that maintains targeted savings deposits as well as provides other financial services, such as checking. In one embodiment, the financial institution can invest automatically the customer's periodic deposits or payments. In one embodiment, the financial institution can pool the customer's targeted saving deposits with other deposits and can invest the pooled deposits in aggregate traunches for purchasing different investment securities to maximize the customer's return. For instance, the financial institution can pool and/or invest the customer's targeted saving deposits in traunches according to the type of securities the customer classifies in his/her request, e.g., designates equity securities or fixed income securities to be purchased with targeted saving deposits. The investments can be further classified according to the expected duration of investments before maturity.

As noted above, the interest or income earned on target saving account balances would vary depending on a yield curve, e.g., if a customer has chosen a fixed income securities account in which to make periodic deposits, or a stock market return, e.g., if a customer has chosen an equity securities investment account for targeted saving. As noted, in some embodiments, an expected duration of each periodic deposit can factor into the rate of return. The expected duration includes the time between each specific deposit or investment and its ultimate redemption or, in other words, a point in time when the targeted saving balance equals the target amount of savings that is required or desired. In some embodiments, the customer can designate different durations not only for each traunch or type of security classified, but within each traunch or security type, such as with respect to each deposit or payment. For instance, some deposits or payments may be designated for equity investment, while others may be specified for investment in fixed income securities.

At stage 455, the central bank computing device 104 provides periodically, e.g., weekly, monthly or quarterly, to the customer a statement reporting information, progress and/or status of the customer's targeted savings efforts, e.g. along with target saving or other account information. As will be described below in further detail, the statement can be any of a variety of correspondence with the customer such as a credit card account statement, a checking account statement, a brokerage account statement or a mortgage account statement, which could be mailed to the customer and/or made available electronically to the customer's computing device 102 via the network 110. The statement can be made available as well through other electronic communication channels, which can be operatively connected to the central bank computing device 104 and/or one or more of the servers 106 and databases, such as, for instance, an automated audio (voice mail)/telephone system. The customer can access or dial into such a system to receive information from the central bank computing device 104 that is presented, e.g., via an audio selection menu, as verbal statements of the customer's account balances, etc. The invention is not limited in this respect, and anticipates that the statement could be made available in a variety of ways including visual and/or textual means and/or in conjunction with or as part of a system comprising a combination of electronic and traditional channels of communication, e.g., postal mail, facsimile and telephone, between the participating financial institution and the customer. Periodic reporting also provides the financial institution with the opportunity to offer the customer incentives, e.g., a gift or a redeemable coupon for a product or service, to help to motivate and to reward the customer for his/her savings efforts in meeting the requirements of the targeted savings plan and/or in reaching the target dollar amount.

At stage 460, when the targeted savings balance equals a target dollar amount, the central bank computing device 104 can notify the customer and can redeem the targeted savings to the customer, for instance, by automatically transferring the target dollar amount to the customer's checking or credit card account in order to provide the customer with access to his/her targeted savings. The financial institution can use the redemption of targeted savings to the customer as an opportunity to personally contact the customer to congratulate the customer and/or to award a certificate of completion and/or to give a gift to the customer for attaining his/her targeted savings goal.

Referring to FIG. 4A, the invention further provides a method 460 of targeted saving wherein targeted saving transactions are conducted between a deposit-gathering financial institution and a customer using one or more financial statements, e.g., a credit card account statement, the financial institution provides to a customer for reporting information related to one or more account. The method 460 can be implemented via the system 100 described above with reference to FIGS. 1-3, and/or can be implemented via one or more other electronic systems, such as voice mail and email systems. In addition, the method 460 can be implemented using traditional means of communication, such as postal mail, facsimile and/or telephone, as described below. The method 460 is exemplary and not limited, and can be altered or modified, e.g., by adding, deleting and/or rearranging stages.

At stage 461, a financial institution, as defined above, can provide a customer, as defined above, with one or more financial statements to report the status and other information related to one or more accounts the financial institution manages for the customer. The financial statement can include, for instance, a debit statement, including a credit card account statement, a mortgage account statement and/or a brokerage account statement. In addition, the financial statement can also include a savings account statement, a checking account statement, a money market account statement, and/or any other type of financial account statement. The financial statement can include one or more solicited or unsolicited offers for targeted savings, such as one or more targeted savings plans, as described above. A solicited offer for targeted savings includes one or more targeted savings plans the financial institution provides to the customer in response to the customer's request or inquiry, and includes data related to one or more targeted savings plans based on one or more variables, such as those variables described above, that the financial institution and/or the customer designate, e.g., via a request format as described above. An unsolicited offer for targeted savings includes one or more targeted savings plans the financial institution offers to the customer in the financial statement, the targeted savings plan can be presented as a portion of the statement or as a separate page of the statement, and can be used by the customer to accept or enroll in targeted savings. In one instance, the customer can provide variables for targeted saving according to one or more of the targeted savings plans offered including a purpose or goal for saving, e.g., to purchase one or more items, a target dollar amount of money to be saved and/or a target date by which the target dollar amount is to be saved.

At stage 462, the financial institution receives the portion of the financial statement the customer uses to either accept one or more of the solicited or unsolicited targeted savings plans offered, and/or to compose one or more requests for one or more targeted savings accounts. Such a financial statement can thereby be used to request, enroll in and participate in targeted savings, as well as to conduct transactions with the financial account to which the financial statement relates. For instance, a credit card statement or other debit statement can offer the customer one or more targeted savings plans and the customer can accept one or more of the offered plans and/or compose one or more requests for targeted savings. A portion of the financial statement can include a request format and/or a payment coupon for composing a targeted savings request(s). Thereafter, the customer can use the credit card statement, e.g., a payment coupon, to make payments to the credit card account and to make targeted savings deposits, e.g., periodically. The targeted savings deposits can be maintained in one or more separate accounts, or can be maintained as available credit on the credit card account.

At stage 463, the financial institution sets up one or more targeted savings accounts in accordance with the one or more targeted savings plans. As noted above, the targeted savings account can be maintained as available credit in a debit account rather than as a separate financial account.

At stage 464, the financial institution receives savings deposits the customer pays periodically to one or more targeted savings accounts. In the instance of a debit account, the customer can make payments to the debit account along with paying deposits to the targeted savings account(s) using, for instance, a portion of the debit statement to indicate the debit payment and the targeted savings deposit(s), such as a payment coupon.

At stage 465, the financial institution reports, e.g., periodically, the status of the targeted savings account(s) using a financial statement, such as a debit statement. The debit statement would report the status of the debit account as well as the progress and status of the customer's targeted savings efforts.

At stage 466, the financial institution pays a rate of return on the one or more balances of the one or more targeted savings accounts/efforts.

At stage 467, the financial institution redeems the balances of the targeted savings deposits when the balances equal the total dollar amounts to be saved. The financial institution can issue a check for such balances or, for instance, provide such balances as available credit on the customer's debit account. The financial statement would further report such redemption of the balances.

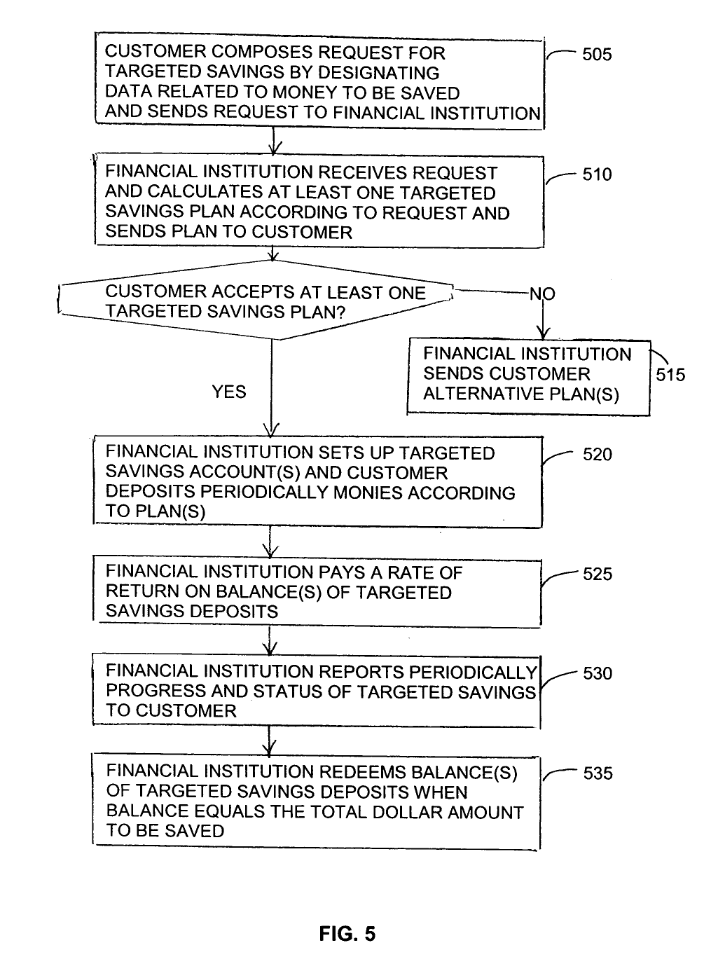

Referring to FIG. 5, the invention provides a method 500 of targeted saving comprising one or more traditional systems or modes of communication and correspondence, e.g., telephone, facsimile and postal mail, between at least one identified customer and at least one participating, deposit-gathering financial institution. The method 500 according to the invention is exemplary only and is not limited. The invention anticipates that stages of the method 500 can be altered, e.g., removed, added and/or rearranged. Those of ordinary skill in the art will appreciate that embodiments of the method 500 include one or more stages that can be accomplished through a combination of any of a variety of electronic and/or network or computer-implemented methods of communication and correspondence, as well as the traditional methods described herein.

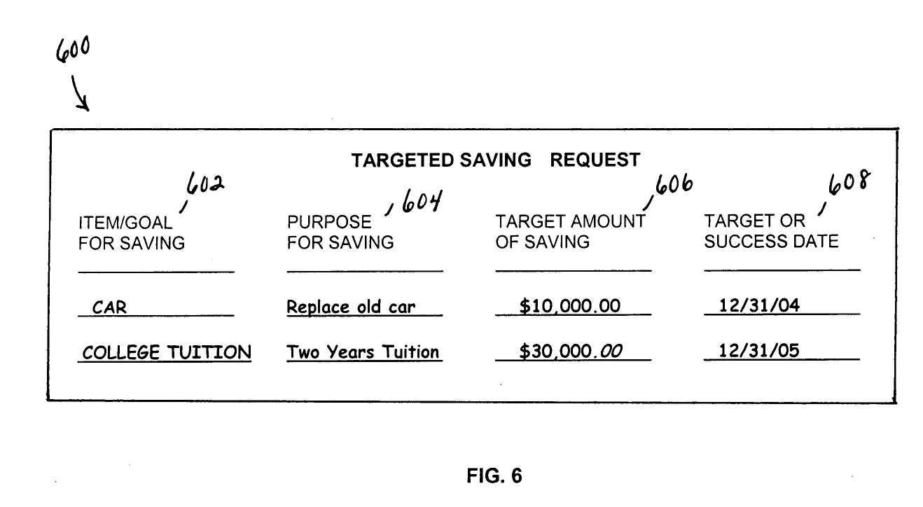

At stage 505, a participating financial institution receives from a customer an inquiry for targeted saving information and/or a request to set up, add to or modify a target saving account and/or to initiate one or more targeted savings transactions, e.g., deposits, payments or withdrawals. The customer can compose the inquiry or request using a format appropriate to send the inquiry or request by postal mail and/or facsimile, or to convey the inquiry or request verbally via telephone. In one embodiment, the inquiry or request can include any of the targeted saving inputs or variables described above with reference to the method 400 and FIG. 4, including, but not limited to, one or more specific items to be purchased and/or investment/savings goals to be met, a target dollar amount of saving, a target or success date by which the target dollar amount is to be saved, and/or an interest rate or investment scheme desired, such as the type or class of investment securities to be purchased using targeted saving deposits and/or an expected duration before maturity of such securities. In one embodiment, the customer can compose the request using a paper format that can include any of a variety of different formats, as will be described below in further detail with reference to FIGS. 6-8. The customer can write or jot down data and targeted saving inputs or variables on the paper format to compose the request.

At stage 510, the financial institution receives the request and, if the request provides sufficient information to process, the financial institution may acknowledge receipt of the request by sending the customer a request or transaction confirmation. In response to a request for targeted saving, the financial institution calculates one or more proposed targeted savings plans, as described above with reference to the method 400 and FIG. 4, and sends one or more plans by postal mail, facsimile and/or by telephone to the customer for review and approval. The customer receives the proposed plans and can review and either approve or reject some or all of the plans.

At stage 515, if the customer rejects at least one of the proposed targeted savings plan(s) and communicates the rejection to the financial institution, the financial institution can propose one or more alternative targeted savings plans.

At stage 520, if the customer accepts at least one of the proposed targeted savings plans and communicates the acceptance to the financial institution, the financial institution sets up or adds to or modifies one or more targeted saving accounts and/or enacts one or more targeted savings transactions according to the customer request. The financial institution can further retain and store the information of the accepted targeted savings plans, as well as other customer data, for further account supervision and management and for future reporting to the customer. Thereafter, the customer makes periodic deposits/payments according to the plan(s).

The targeted savings request(s), proposed plan(s) and periodic deposits can be transacted between the financial institution and the customer using a debit statement, e.g., as a request format, a proposal of targeted savings plan(s) and/or to deposit monies periodically. In these cases, for instance, the debit statement can include a credit card statement. Targeted savings requests and payments can use, for instance, a portion of the statement to identify data related to a request or payment, as will be described below. In addition, the financial institution can use the credit card statement to offer solicited or unsolicited targeted savings plan(s) by the customer.

At stage 525, the financial institution pays a rate of return on targeted saving deposits and/or investment payments, e.g., in accordance with the customer's request.

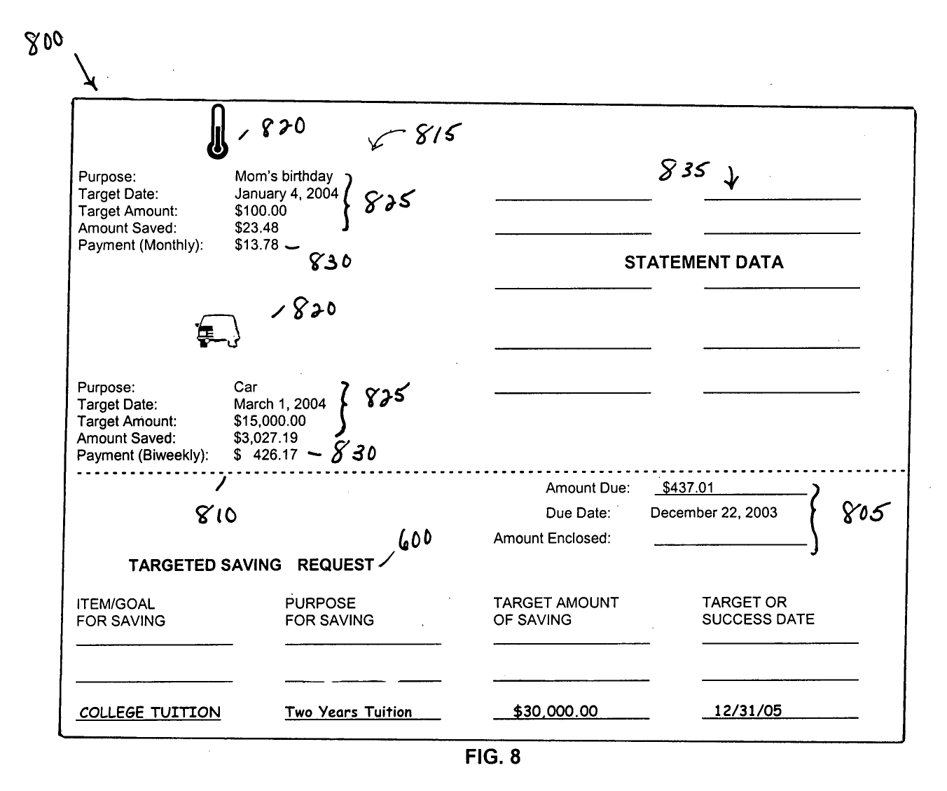

At stage 530, the financial institution reports periodically, e.g., weekly, monthly, or quarterly, to the customer the progress and the status of the customer's targeted savings efforts by furnishing any of a variety of correspondence such as a statement that provides current and, optionally, historical information about each target saving account. Such a statement can include a bank statement, a checking account statement, a brokerage account statement or any other type of financial statement or report, as will be described below in further detail with reference to FIG. 8.

At stage 535, when a target saving account holds the target amount of savings at or before the predetermined target/success date, the financial institution may notify the customer or may redeem the targeted savings to the customer, for instance, by automatically transferring the funds from the target saving account to the customer's checking or credit card account such that the customer may debit the targeted savings from the account using a check or credit card.

With respect to the methods 400 and 500 according to the invention, shortfalls in the target dollar amount of saving can be guarded against. If the customer misses a targeted saving deposit, the financial institution can automatically remind the customer of the deposit due and provide an opportunity to make a payment then or at the time of the next periodic deposit. In one embodiment, the financial institution can also provide the option to have the remaining deposits increased to account for the missed payment. For instance, if the customer misses two or more consecutive deposits, the financial institution can provide the customer with several options, e.g., make the payments upon a reminder; make the payments when the next payment is due; withdraw the savings to date; reset the target date and/or reset the target amount. Similar measures can be taken if the anticipated return on the customer's investment exceeds the actual return. For instance, it the actual return deviates below the anticipated return, the customer's payments can be automatically increased if the increase is below a specified incremental maximum relative to the previous payment and/or below a cumulative maximum relative to the first payment. The customer can elect to increase payments beyond the specified maximums.

In the event of a shortfall in targeted savings relative to the target dollar amount desired or required when the target date arrives, the customer again can be given several options. The customer may take the savings despite the shortfall. The customer can elect to make one or more additional payments, or to extend the target date, until the target amount is reached. The customer may also reset the target amount, or reset the target amount and target date for another item for which the customer wishes to save.

Referring to FIG. 6, in one embodiment, the invention provides a request format 600 for a new target saving account or for a transaction with an existing target saving account for use with at least the methods 400 and 500, as described above. The request format 600 according to the invention can comprise any of a variety of electronic forms including, for instance, one or more HTML documents and/or web pages that the central bank computing device 104 and/or the server 106 provide to the customer, e.g., via the customer computing device 102. In another embodiment, the request format 600 can comprise any form suitable for the financial institution to convey the request format 600 to the customer using other types of electronic communication systems including, for instance, an electronic (email) message system or an audio (voice mail)/telephone system. In a further embodiment, the request format 600 can comprise a paper format that the financial institution sends to the customer by traditional modes of correspondence including facsimile and/or postal mail for the customer to complete by hand and to return to the financial institution by facsimile and/or postal mail. In still other embodiments, the request format 600 can comprise a combination format whereby, for instance, the central bank computing device 104 transmits the request format 600 in electronic format to the customer computing device 102, which receives, downloads and prints the request format 600 in paper format for the customer to complete and the financial institution to receive by fax and/or mail. In one embodiment, the request format 600 is incorporated with a debit statement, such as a credit card statement, as will be described below in further detail with reference to FIG. 8.

The request format 600 illustrated in FIG. 6 is exemplary only and is not limited by form and/or content. Those of ordinary skill in the art will appreciate that the request format 600 can be varied and modified to collect different and/or additional data from the customer to comprise a targeted savings request format 600.

As shown in FIG. 6, data inputs or variables, as described above, can be collected by the request format 600. The request format 600 can include portions and/or spaces for the customer to designate the specific item(s) and/or investment goal(s) 602 the customer would like to target some or all of his/her incremental savings toward and, optionally, to identify a purpose 604 of such targeted savings. In addition, the request format 600 can include portions and/or spaces for the customer to designate a target or total dollar amount of saving to be saved 606 and/or a target or success date 608 by which the customer would like to save the target dollar amount. For instance, as shown in FIG. 6, the customer designates a car at 602 for the purpose of replacing an old car at 604, and designates a target dollar amount of $10,000 at 606 and a target/success date of Dec. 31, 2004 at 608. In another instance, using the request format 600, the customer designates an investment goal of saving two years of college tuition at 602, a target dollar amount of savings of $30,000 at 606, and a target/success date of Dec. 31, 2005 at 608. The request format 600 can further include additional portions and/or spaces (not shown) to designate any other variables associated with a targeted savings plan according to the invention such as, for instance, a dollar amount of each incremental deposit that the customer needs and/or prefers to pay periodically toward the target dollar amount of saving.

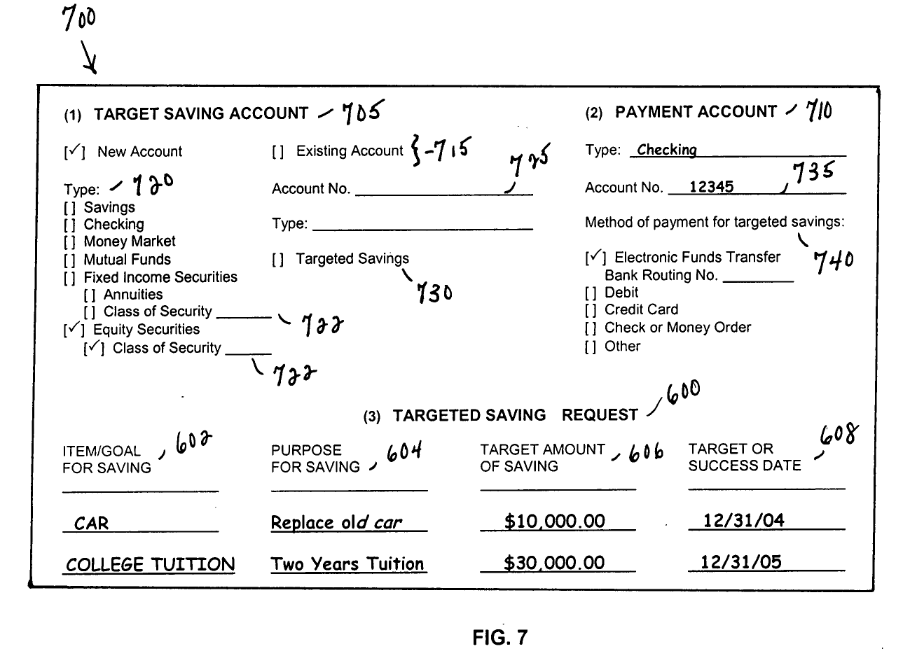

The request format 600 can be configured into or incorporated with any of a variety of forms the financial institution uses to correspond or communicate with and/or to collect data from its customers. Referring to FIG. 7, in one embodiment, the request format 600 can include one or more separate sections, as indicated by numeral “(3)” shown in FIG. 7, or one or more separate pages of an advertisement, a questionnaire or a form 700 that the customer responds to and/or completes such that the financial institution receives the required data inputs or variables, e.g., to set up a new target saving account. Like the request format 600 as described above, the form 700 can be provided in any of a variety of formats including, for instance, an electronic format comprising one or more HTML documents and/or associated software or one or more web pages of a website, each being transmitted by and accessed through the network 110. In addition, the form 700 can comprise other electronic formats as well as paper formats.

As indicated by numerals “(1)” and “(2)” shown in FIG. 7, the form 700 can provide sections and/or spaces for the customer to designate a first or target saving account 705 into which incremental saving deposits will be made, and to designate a second or payment account 710 from which monies will be withdrawn or debited to fund the deposits to the first account. In one embodiment, the form 700 can list options from which the customer selects the first and the second accounts 705 and 710. If the customer designates or selects a new account 715, in one embodiment, the form 700 permits the customer to indicate the type of account 720 that the customer desires for targeted saving and/or for other purposes, such as checking. If the customer designates an existing account 715 for targeted saving, the form 700 provides for the customer identifying an account number 725 and indicating whether the existing account is an existing target saving account 730.

The form 700 can permit the customer to essentially set up or request as many target saving accounts as the customer requires or desires. One or more accounts can be designated solely for purposes of targeted saving, while one or more other accounts can be designated for targeted saving as well as for other purposes, such as checking. For instance, an investment broker account used to purchase and manage investment securities can be used for targeted saving according to the invention. The financial institution or brokerage firm handling the account and purchasing securities on behalf of the customer can target a customer-designated portion of investment deposits/purchases, or a customer-designated portion of interest/income earned by such securities, toward targeted saving for specific items and/or investment goals. The interest/income earned may not be redeemed or transferred from the broker account, but may be maintained in the account for purposes of targeted saving and/or reinvested.

As will be described below in detail with reference to FIG. 8, the total dollar amount of targeted saving deposits, or the balance of a target saving account, can be reported separately from other deposits or accounts, and along with other information related to target saving or other accounts.

In one embodiment, where the designated target saving account 705 is a new account, the form 700 provides for the customer further indicating or selecting the type of account 720 that the customer would like the financial institution to deposit and/or to invest his/her targeted saving deposits. For instance, the form 700 can provide for allowing the customer to select the type of account 720 that will serve as the first or target saving account such as, for instance, an interest-bearing savings or checking account and/or an investment account including a money market, mutual fund, securities account 720. Within this account selection 720, the form 700 can further provide for the customer to classify the type of investment securities 722, e.g., fixed income securities and/or equity investment securities, that the customer would like the financial institution to invest his/her targeted saving deposits. In addition, the form 700 can provide for the customer to designate the different types of securities to be purchased with individual and separate saving deposits (not shown) such that an individual deposit can be designated for purchasing one class of securities while another individual deposit can be dedicated for purchasing a second class of securities. For instance, the customer may designate every other periodic saving deposit for investment in a mutual fund account, while the remaining deposits are for purchasing a designated fixed income security.

In addition to classifying the type of investment securities for targeted saving, the form 700 can provide for the customer designating the preferred or required duration of each investment to maturity (not shown). Also, the form 700 can further provide for the customer indicating a different duration of investment to maturity for each individual deposit into the target saving account (not shown).

In the portion identified by the numeral “(2)” shown in FIG. 7, the form 700 can provide for the customer designating a type of the second or payment account 710 to be used to fund targeted saving deposits and identifying the payment account 735, e.g. by providing an account number. In addition, the form 700 can provide for the customer further selecting a mode of payment 740, e.g., electronic funds transfer, debit withdrawal, credit card, check or money order or other form of payment.

Embodiments of the invention in which the targeted savings request format 600 is incorporated with the form 700 in an electronic format, the customer enters and/or selects data with the customer computing device 102 using the input device 122, e.g., a keyboard, a mouse, a touch screen or a numeric pad, to complete the request format 600. Embodiments in which the request format 600 comprises a portion of the form 700 in paper format requires that the customer handwrite pertinent data along the spaces 602, 604, 606 and 608 and in the portions identified as “(1)” and “(2)” to complete the targeted savings request format 600.

Referring to FIG. 8, the request format 600, or the form 700 in which the request format 600 is incorporated with, can define any of a variety of forms the financial institution uses to correspond with a customer and can include, for instance, one or more special sections or separate pages of an account statement 800, such as a debit statement including a credit card account statement, a mortgage account statement, or a brokerage account statement, that the financial institution provides periodically to the customer. The statement 800 can serve a number of purposes in addition to reporting account information to a customer including, for instance, offering one or more unsolicited, e.g., not customer requested, targeted savings plans, setting up a new target savings account, making a payment to an existing target savings account and/or making a payment to one or more other accounts, such as a credit card account that the customer holds. In one embodiment, the request format 600 is included in a credit card statement that identifies, for instance, a customer's outstanding account balance, a minimum payment due, a due date for payment, a finance charge and any other information related to the customer's credit card account. The customer can use the request format 600 to set up a target savings account or to make a payment/deposit to a target savings account whereby the customer can send a targeted savings request or targeted savings payment/deposit to the financial institution along with a credit card payment. In addition, the customer can use the request format 600 to respond to any unsolicited offers for targeted savings that the financial institution includes in the account statement 800.

In embodiments of the invention in which the statement 800 includes a paper format, a customer can complete the request format 600 portion of the statement 800 by handwriting data required to complete the request format 600. The request portion 600 can be detached from the statement 800 by tearing the statement 800 along a line of perforations 810 and returned to the financial institution along with a credit card payment and/or a payment to an existing target saving account.

In addition, the statement 800 can indicate payment information 805 concerning other accounts the financial institution handles for the customer including existing target saving accounts and/or other accounts such as checking and credit card accounts.

In one embodiment, the statement 800 can include a special section 815 or a separate page displaying an icon 820 and a target saving listing 825 that provide visual and textual information reporting the status and the progress of the customer's targeted savings efforts. The icon 820 and/or the listing 825 can indicate what item(s) the customer wants to buy and/or what investment goal(s) the customers wants to attain, a target dollar amount of saving and/or a target or success date. The icon 820 can be any of a number of different designs, such as the thermometer or gauge/meter shown, or it could be a depiction of the item for which the customer is saving. For instance, as shown in FIG. 8, where the customer is saving for a car, the icon 820 can include the frame or outline of a car, with the car being incrementally colored in or completed with each periodic deposit or payment toward the target amount of saving. Each time the customer makes a targeted saving deposit or payment, a portion of the icon 820 will fill in.

The statement 800 provides the customer, e.g., each month, with informational feedback with respect to the balance of each target saving account, or the balance of saving deposits targeted for a single purpose or goal, that is augmented by any interest or income earned. The statement 800 can refer to such interest or income earned on each balance as a CAPITAL APPRECIATION DEPOSIT™ (not shown). As discussed above, the interest or income earned, or the CAPITAL APPRECIATION DEPOSIT™, on the ascending balances of target saving accounts or deposits, can vary, e.g., automatically, depending on an investment scheme the customer has selected and the expected duration of each deposit or investment to maturity, e.g., the target date or date by which the targeted saving is to be redeemed. The specific periodic interest or income earned can be displayed, for instance, in the target saving listing 825 of the statement 800, and/or can be provided as a separate data section or page 835 of the statement 800.

The section 815 can further include the amount and frequency of each incremental deposit or payment 830 that the customer is required to make to reach the target amount of saving. The required deposit or payment 830 displayed in the statement 800 is less than a simple division of the remaining amount to be saved by the remaining months to the target or success date since the interest or income that the financial institution will pay to the customer is factored automatically into the deposit or payment required 830.

The listing 825 and/or the data section 835 of the statement 800 can identify the target saving accounts and other accounts the financial institution manages for the customer, e.g., by account number, and can provide account information including a current interest rate, or the CAPITAL APPRECIATION DEPOSITS™ (not shown), the type of account, the class of securities, maturity dates and other related information.

The statement 800 can be configured to provide both textual and/or visual information, as described above, such that the customer can easily assess his/her overall progress with respect to meeting the target dollar amounts and the goals of the targeted savings plans. In particular, the targeting of each incremental saving deposit toward one or more purposes and the reporting of the progress of such savings efforts according to the specific item or purpose for which the customer is targeting his/her savings helps to reinforce the customer's savings efforts and to motivate the customer to continue saving.

As with any situation in which an entity holds money of others, depositors and investors should be concerned with the safety of a bank, mutual fund, a brokerage firm or a credit card company that holds and manages depositors' and investors' money. Such financial institutions may choose to purchase securities and/or “rent” or use some of all of the targeted saving monies themselves for lending purposes. Customers should understand the credit quality of any securities purchased by such financial institutions including, for instance, whether there is an overall government guarantee. Customer targeted saving deposits used by financial institutions may have to be backed by a government guarantee or securitized by a highly rated guarantor to satisfy depositing customers.

Targeted saving deposits can be run through an established bank, for instance, to give depositing customers the benefit of government insurance on their deposits. Running customers' fixed income monies through an FDIC or other government agency insured financial institution could provide such benefit. In addition, equities could be guaranteed with respect to proper possession and accounting procedures, for instance, in cooperation with large highly regarded brokerage firms and/or the currently available government guaranty program. To avoid potential concern that savings might be impaired, providers of targeted saving services could specifically waive the right of offset.

The invention may be embodied in other specific forms without departing from the spirit and essential characteristics thereof. The present embodiments are therefore to be considered as illustrative and not restrictive. As described above, the invention can be implemented through network or computer-implemented systems and associated software programs/codes that instruct the computing devices and the systems to conduct various operations. Due to the nature of software and computers, one skilled in the art will readily recognize that the invention can be embodied in hardwiring hardware, firmware, and/or software or combinations of any of these.

1. A method of targeting savings comprising:
providing a request format to a user to target savings deposits, the request format being a part of a debit statement a financial institution provides to the user;
composing a request to target savings deposits using the request format, the request including data the user designates; and
sending the request format to the financial institution.

2. The method of claim 1 wherein the data the user designates includes a total dollar amount of money to be saved.

3. The method of claim 1 wherein the data the user designates includes a target date by which a total dollar amount of money is to be saved.

4. The method of claim 1 wherein the data the user designates includes a dollar amount for one or more periodic savings deposits the user pays to the financial institution.

5. The method of claim 1 wherein the data the user designates includes one or more purposes for which money is to be saved.

6. The method of claim 2 wherein the data the user designates includes a target date by which the total dollar amount of money is to be saved.

7. The method of claim 6 wherein the data the user designates includes a dollar amount for one or more periodic savings deposits the user pays to the financial institution to save the total dollar amount.

8. The method of claim 7 wherein the data the user designates includes one or more purposes for which the total dollar amount of money is to be saved.

9. The method of claim 1 wherein the debit statement includes at least one targeted savings plan the financial institution offers to the user.

10. The method of claim 1 further comprising providing at least one targeted savings plan to the user in response to the request to target savings deposits.

11. The method of claim 10 wherein the at least one targeted savings plan is part of a debit statement the financial institution provides to the user.

12. The method of claim 10 wherein the at least one targeted savings plan includes a total dollar amount of money to be saved.

13. The method of claim 12 wherein the at least one targeted savings plan includes a target date by which the total dollar amount of money is to be saved.

14. The method of claim 10 wherein the at least one targeted savings plan includes a dollar amount for one or more periodic savings deposits the user pays to the financial institution.

15. The method of claim 14 wherein the at least one targeted savings plan includes a rate of return the financial institution pays on a balance of the one or more periodic savings deposits.

16. The method of claim 15 wherein the financial institution pays the rate of return periodically.

17. The method of claim 15 wherein the rate of return includes at least one of a fixed rate of return and a variable rate of return.

18. The method of claim 14 wherein the at least one targeted savings plan includes a designation of one or more types of securities the financial institution purchases with the one or more periodic savings deposits.

19. The method of claim 18 wherein the financial institution uses a portion of the periodic savings deposits to purchase one type of security and one or more other portions of the periodic savings deposits to purchase one or more other types of securities.

20. The method of claim 10 further comprising receiving at the financial institution an acceptance from the user of the at least one targeted savings plan.

21. The method of claim 14 further comprising receiving at the financial institution the one or more periodic savings deposits the user pays to the financial institution according to the at least one targeted savings plan.

22. The method of claim 14 wherein a portion of at least one of the periodic savings deposits includes a debit payment.

23. The method of claim 14 further comprising increasing a balance of the periodic savings deposits the financial institution holds, the financial institution paying a rate of return on the balance.

24. The method of claim 23 wherein the financial institution pays the rate of return periodically.

25. The method of claim 23 wherein the rate of return includes at least one of a fixed rate of return and a variable rate of return.

26. The method of claim 14 further comprising reporting at least a balance of the one or more periodic savings deposits the financial institution holds for the user.

27. The method of claim 26 wherein the balance is reported in a debit statement the financial institution provides to the user.

28. The method of claim 27 wherein the debit statement includes a target date by which a total dollar amount of money is to be saved.

29. The method of claim 27 wherein the debit statement includes a dollar amount required for the next periodic savings depositing.

30. The method of claim 27 wherein the debit statement includes a rate of return the financial institution pays on the balance of the one or more periodic savings deposits.

31. The method of claim 27 wherein the debit statement includes a balance of one or more outstanding periodic savings deposits the user has not paid the financial institution according to the at least one targeted savings plan.

32. The method of claim 31 wherein the debit statement includes one or more options for the user to remit the one or more outstanding periodic savings deposits.

33. The method of claim 7 further comprising redeeming a balance of the one or more periodic savings deposits the user pays to the financial institution.

34. The method of claim 33 wherein redeeming the balance of the one or more periodic savings deposits includes redeeming the balance when the balance equals the total dollar amount of money to be saved.

35. The method of claim 33 wherein redeeming the balance of the one or more periodic savings deposits includes redeeming the balance when the target date for saving occurs.

36. The method of claim 33 wherein redeeming the balance of the one or more periodic savings deposits includes redeeming the balance in response to a request from the user.

37. The method of claim 1 wherein the debit statement includes one or more of a credit card statement, a mortgage statement and a brokerage account statement.

38. A network-implemented system of targeting savings comprising:
at least one customer computing device operatively coupled to a network for operation by at least one user;
at least one central bank computing device operatively coupled to the network for operation by at least one financial institution, each of the central bank computing device and the customer computing device being configured and arranged to establish a communications and data exchange link with one another through the network;
the central bank computing device being programmed to transmit to the customer computing device a request format for the user to target savings deposits, the request format being a part of a debit statement the financial institution provides to the user;
the central bank computing device being programmed to receive the request format the customer computing device transmits to the central bank computing device, the request format being composed by the user using the customer computing device and including data the user designates; and
the central bank computing device being further programmed to receive the request format with a debit payment to the financial institution the customer computing device transmits to the central bank computing device.

39. The system of claim 38 wherein the data the user designates includes a total dollar amount of money to be saved.

40. The system of claim 38 wherein the data the user designates includes a target date by which a total dollar amount of money is to be saved.

41. The system of claim 38 wherein the data the user designates includes a dollar amount for one or more periodic savings deposits the user pays to the financial institution.

42. The system of claim 38 wherein the data the user designates includes one or more purposes for which money is to be saved.

43. The system of claim 39 wherein the data the user designates includes a target date by which the total dollar amount of money is to be saved.

44. The system of claim 43 wherein the data the user designates includes a dollar amount for one or more periodic savings deposits the user pays to the financial institution to save the total dollar amount.

45. The system of claim 44 wherein the data the user designates includes one or more purposes for which the total dollar amount of money is to be saved.

46. The system of claim 38 wherein the debit statement includes at least one targeted savings plan the financial institution offers to the user.

47. The system of claim 38 further comprising the central bank computing device being programmed to transmit to the customer computing device at least one targeted savings plan in response to receipt of the request format.

48. The system of claim 47 wherein the at least one targeted savings plan is part of a debit statement the financial institution provides to the user.

49. The system of claim 30 wherein the at least one targeted savings plan includes a total dollar amount of money to be saved.

50. The system of claim 49 wherein the at least one targeted savings plan includes a target date by which the total dollar amount of money is to be saved.

51. The system of claim 47 wherein the at least one targeted savings plan includes a dollar amount for one or more periodic savings deposits the user pays to the financial institution.

52. The system of claim 51 wherein the at least one targeted savings plan includes a rate of return the financial institution pays on a balance of the one or more periodic savings deposits.

53. The system of claim 52 wherein the financial institution pays the rate of return periodically.

54. The system of claim 53 wherein the rate of return includes at least one of a fixed rate of return and a variable rate of return.

55. The system of claim 51 wherein the at least one targeted savings plan includes a designation of one or more types of securities the financial institution purchases with the one or more periodic savings deposits.

56. The system of claim 51 wherein the financial institution uses a portion of the periodic savings deposits to purchase one type of security and one or more other portions of the periodic savings deposits to purchase one or more other types of securities.

57. The system of claim 47 further comprising the central bank computing device being programmed to receive an acceptance of the at least one targeted savings plan the user transmits to the central bank computing device using the customer computing device.

58. The system of claim 51 further comprising the customer computing device being programmed to transmit instructions to the central bank computing device to cause the one or more periodic savings deposits to be paid to the financial institution according to the at least one targeted savings plan.

59. The system of claim 58 further comprising the central bank computing device being programmed to receive the instructions the customer computing device transmits.

60. The system of claim 58 wherein a portion of at least one of the periodic savings deposits includes a debit payment.

61. The system of claim 51 further comprising the central bank computing device being programmed to increase a balance of the periodic savings deposits the financial institution holds by a rate of return.

62. The system of claim 61 wherein the rate of return is paid periodically.

63. The system of claim 61 wherein the rate of return includes at least one of a fixed rate of return. and a variable rate of return.

64. The system of claim 51 further comprising the central bank computing device being programmed to transmit a statement to the customer computing device to report at least a balance of the periodic savings deposits the financial institution holds.

65. The system of claim 64 wherein the statement includes a target date by which a total dollar amount of money is to be saved.

66. The system of claim 64 wherein the statement includes a dollar amount required for the next periodic savings deposit.

67. The system of claim 64 wherein the statement further includes a rate of return the financial institution pays on the balance of the one or more periodic savings deposits.

68. The system of claim 64 wherein the statement includes a balance of one or more outstanding periodic savings deposits the user has not paid the financial institution according to the at least one targeted savings plan.

69. The system of claim 68 wherein the statement includes one or more options for the user to remit the one or more outstanding periodic savings deposits.

70. The system of claim 51 further comprising the central bank computing device being programmed for redeeming the balance of the one or more periodic savings deposits to the user.

71. The system of claim 70 wherein redeeming the balance of the one or more periodic savings deposits includes redeeming the balance when the balance equals the total dollar amount of money to be saved.

72. The system of claim 70 wherein redeeming the balance of the one or more periodic savings deposits includes redeeming the balance when the target date for saving occurs.

73. The system of claim 70 wherein redeeming the balance of the one or more periodic savings deposits includes redeeming the balance in response to a request from the user.

74. The system of claim 38 the debit statement includes one or more of a credit card statement, a mortgage statement and a brokerage account statement.

75. A method of targeting savings comprising:
providing a request format to a user to target savings deposits, the request format being a part of a debit statement a financial institution provides to the user in an electronic form using computing means configured to access and to establish a communications link with a network;
composing a request to target savings deposits using the request format, the request including data the user designates; and
sending the request format to the financial institution.

76. The method of claim 75 wherein the network includes a network the user can access and establish a communications link with using computing means.

77. The method of claim 76 wherein the computing means is selected from the group of devices including an Internet appliance, a mainframe computer, a personal computer, a laptop computer, a personal digital device, a mobile communications device, a workstation, an interconnected group of computers and any combination thereof.

78. The method of claim 75 wherein sending the request format to the financial institution includes the user sending the request format to the financial institution using computing means configured to access and to establish a communications link with the network.

79. A method of targeting savings comprising:
providing a request format to a user configured to target savings deposits, the request format being a part of a statement a financial institution provides to the user;
composing a request to target savings deposits using the request format, the request including data the user designates; and
sending the request format to the financial institution.

80. The method of claim 79 wherein the statement includes one of a credit card account statement, a mortgage account statement, a brokerage account statement, a checking account statement and a savings account statement.

81. The method of claim 79 wherein the statement includes targeted savings data related to one or more targeted savings efforts.

82. The method of claim 81 wherein the request format is further configured as a payment coupon to identify payment of one or more periodic targeted savings deposits toward the one or more targeted savings efforts.

83. The method of claim 82 wherein the payment coupon is further configured to identify payment to an account for which the statement issues.

84. The method of claim 81 wherein the targeted savings data includes at least one of a target dollar amount of money to be saved, a purpose for saving a target dollar amount of money, a target date by which a target dollar amount of money is to be saved, an amount of a periodic targeted savings deposit, a balance of periodic targeted savings deposits paid and a rate of return on a balance of periodic targeted savings deposits paid.

85. The method of claim 84 further including one or more design icons configured to represent the balance of periodic targeted savings deposits relative to a target dollar amount of money to be saved.

86. The method of claim 85 wherein the one or more design icons include one of a meter design icon, a gauge design icon, a thermometer design icon, a pie design icon and combinations thereof.

87. The method of claim 85 wherein the one or more design icons include a design icon configured to represent an item to be purchased when the balance of periodic targeted savings deposits paid equals the total dollar amount of money to be saved.

88. The method of claim 81 wherein the targeted savings data includes one or more periodic targeted savings deposits paid toward one or more targeted savings efforts, and wherein the one or more periodic targeted savings deposits paid are represented in the statement as one or more account transactions.

89. The method of claim 79 wherein the data the user designates includes one or more of a target dollar amount of money to be saved, a target date by which a target dollar amount of money is to be saved, a dollar amount for one or more periodic targeted savings deposits, and a purpose for which money is to be saved

90. The method of claim 79 further comprising the financial institution providing to the user at least one targeted savings plan configured in response to the user's request to target savings deposits.

91. The method of claim 90 wherein the at least one targeted savings plan identifies one or more of a target dollar amount of money to be saved, a target date by which a target dollar amount of money is to be saved, a dollar amount for one or more periodic targeted savings deposits, a purpose for which money is to be saved, and a rate of return on a balance of periodic targeted savings deposits.

92. The method of claim 91 further comprising receiving at the financial institution the one or more periodic targeted savings deposits the user pays.

93. The method of claim 92 further comprising the financial institution increasing a balance of the one or more periodic targeted savings deposits by paying a rate of return on the balance.

94. The method of claim 92 further comprising the financial institution reporting at least a balance of the one or more periodic targeted savings deposits.

95. The method of claim 92 further comprising redeeming a balance of the one or more periodic targeted savings deposits to the user when the balance equals a target dollar amount of money to be saved.
